(19) United States
(12) Patent Application Publication
(10) Pub. No.: US 2025/0296549 A1
(43) Pub. Date: Sep. 25, 2025

(54) SYSTEMS AND METHODS FOR PERFORMING ENHANCED SELF-PARK MANEUVER USING AUDIO SENSOR INPUT

(71) Applicants: Hyundai Motor Company, Seoul (KR); Kia Corporation, Seoul (KR)

(72) Inventors: Tuncer Yumak, Taylor, MI (US); Ashwin Kulkarni, Superior Township, MI (US); Bilal Javaid, Ada, MI (US)

(21) Appl. No.: 18/610,921

(22) Filed: Mar. 20, 2024

(51) Int. Cl. B60W 30/06; B60W 30/09; B60W 30/095; G06N 3/08

(52) U.S. Cl. CPC B60W 30/06; B60W 30/09; B60W 30/0956; G06N 3/08; B60W 2420/40; B60W 2420/54; B60W 2554/402; B60W 2556/20

(57) ABSTRACT

Systems and methods for performing enhanced self-park maneuvers are provided. The system may comprise one or more audio sensors coupled to a vehicle configured to generate audio sensor data, one or more visual sensors coupled to the vehicle configured to generate visual sensor data, and a computing device, comprising a processor and a memory. The memory may comprise instructions that, when executed by the processor, are configured to cause the processor to cause the vehicle to perform a remote smart parking assist (RSPA) function to self-park the vehicle, receive the audio sensor data and the visual sensor data, calculate a risk evaluation based on the audio sensor data and the visual sensor data, using a neural network, generate a confidence score based on the risk evaluation, and determine one or more suitable actions for the vehicle to take, based on the confidence score.

### BACKGROUND

### Technical Field

Embodiments of the present disclosure relate to systems and methods for performing enhanced self-park maneuvers using audio sensor inputs.

### Background

Many vehicles are produced with self-park features, enabling the vehicles to automatically perform parking maneuvers. This is often referred to as smart parking. Smart parking system algorithms are typically based on camera and ultrasound sensor inputs. However, they do not use audio inputs.

By excluding audio sensor inputs, vehicles cannot react to sounds that require attention (e.g., horn honking, human speech, animal sound) during a self-park maneuver.

For at least these reasons, systems and methods for performing self-park maneuvers while incorporating audio sensor inputs is needed.

### SUMMARY

According to an object of the present disclosure, a system for performing enhanced self-park maneuvers is provided. The system may comprise one or more audio sensors coupled to a vehicle configured to generate audio sensor data of an environment of the vehicle, one or more visual sensors coupled to the vehicle configured to generate visual sensor data of an environment of the vehicle, and a computing device, comprising a processor and a memory. The memory may comprise instructions that, when executed by the processor, are configured to cause the processor to cause the vehicle to perform a remote smart parking assist (RSPA) function to self-park the vehicle, receive the audio sensor data and the visual sensor data, calculate a risk evaluation based on the audio sensor data and the visual sensor data, using a neural network, generate a confidence score based on the risk evaluation, and determine one or more suitable actions for the vehicle to take, based on the confidence score.

According to an exemplary embodiment, calculating the risk evaluation may comprise training the neural network according to a training feedback loop.

According to an exemplary embodiment, generating the confidence score may comprise calculating the confidence score to be low when the confidence score is below a first threshold, calculating the confidence score as medium when the confidence score is above the first threshold and below a second threshold, and calculating the confidence score as high when the confidence score is above the second threshold.

According to an exemplary embodiment, when the confidence score is low, the one or more suitable actions may comprise terminating the RSPA function and returning control of the vehicle to a driver.

According to an exemplary embodiment, when the confidence score is medium, the one or more suitable actions may comprise proceeding with the RSPA function with implementation of one or more cautionary functions.

According to an exemplary embodiment, when the confidence score is high, the one or more suitable actions may comprise proceeding with completion of the RSPA function.

According to an exemplary embodiment, the one or more cautionary functions may comprise one or more of the following: reducing a speed of the vehicle; turning on headlights of the vehicle; turning on hazard lights of the vehicle; increasing a sensor sampling rate of the one or more audio sensors; or increasing a sensor sampling rate of the one or more visual sensors.

According to an exemplary embodiment, the instructions, when executed by the processor, may be further configured to cause the processor to perform the one or more suitable actions.

According to an exemplary embodiment, the calculating the risk evaluation may comprise analyzing the visual sensor data to determine whether one or more humans and/or animals are present within the visual sensor data.

According to an exemplary embodiment, the calculating the risk evaluation may comprise analyzing the visual sensor data to determine whether one or more vehicles are present within the visual sensor data.

According to an exemplary embodiment, the calculating the risk evaluation may comprise analyzing the visual sensor data to identify a vehicle horn sound from the audio sensor data to determine one or more characteristics of the vehicle horn sound.

According to an exemplary embodiment, the calculating the risk evaluation may comprise analyzing the visual sensor data to, based on the one or more characteristics, match the vehicle horn sound to a vehicle model.

According to an exemplary embodiment, the calculating the risk evaluation may comprise analyzing the visual sensor data to determine whether one or more sounds from the audio sensor data belong to one or more animals or humans.

According to an exemplary embodiment, the calculating the risk evaluation may comprise analyzing the visual sensor data to determine, based on one or more sound characteristics, whether one or more sounds from the audio sensor data are generated from one or more objects that are approaching the vehicle.

According to an exemplary embodiment, the calculating the risk evaluation may comprise analyzing the visual sensor data to determine, based on one or more sound characteristics, whether one or more sounds from the audio sensor data are generated from one or more objects that are departing from the vehicle.

According to an exemplary embodiment, the calculating the risk evaluation may comprise analyzing the visual sensor data and the audio sensor data to match speech to a visual detection of lip movement.

According to an exemplary embodiment, the calculating the risk evaluation may comprise analyzing the visual sensor data and the audio sensor data to match a horn sound to a visual detection of a secondary vehicle.

According to an exemplary embodiment, the system may comprise the vehicle.

According to an exemplary embodiment, the vehicle may comprise an autonomous vehicle and/or a semi-autonomous vehicle.

According to an object of the present disclosure, a method for performing enhanced self-park maneuvers is provided. The method may comprise generating audio sensor data of an environment of a vehicle via one or more audio sensors coupled to the vehicle, generating visual sensor data of an environment of the vehicle via one or more visual sensors coupled to the vehicle, and, using a computing device, comprising a processor and a memory, receiving the audio sensor data and the visual sensor data, calculating a risk evaluation based on the audio sensor data and the visual sensor data, using a neural network, generating a confidence score based on the risk evaluation, determining one or more suitable actions for the vehicle to take, based on the confidence score, and performing the one or more suitable actions.

According to an exemplary embodiment, calculating the risk evaluation may comprise training the neural network according to a training feedback loop.

According to an exemplary embodiment, generating the confidence score may comprise calculating the confidence score to be low when the confidence score is below a first threshold, calculating the confidence score as medium when the confidence score is above the first threshold and below a second threshold, and calculating the confidence score as high when the confidence score is above the second threshold.

According to an exemplary embodiment, when the confidence score is low, the one or more suitable actions may comprise terminating an RSPA function and returning control of the vehicle to a driver.

According to an exemplary embodiment, when the confidence score is medium, the one or more suitable actions may comprise proceeding with the RSPA function with implementation of one or more cautionary functions.

According to an exemplary embodiment, when the confidence score is high, the one or more suitable actions may comprise performing the RSPA function.

According to an exemplary embodiment, the one or more cautionary functions may comprise one or more of the following: reducing a speed of the vehicle; turning on headlights of the vehicle; turning on hazard lights of the vehicle; increasing a sensor sampling rate of the one or more audio sensors; or increasing a sensor sampling rate of the one or more visual sensors.

According to an exemplary embodiment, the calculating the risk evaluation may comprise analyzing the visual sensor data to determine whether one or more humans and/or animals are present within the visual sensor data.

According to an exemplary embodiment, the calculating the risk evaluation may comprise analyzing the visual sensor data to determine whether one or more vehicles are present within the visual sensor data.

According to an exemplary embodiment, the calculating the risk evaluation may comprise analyzing the visual sensor data to identify a vehicle horn sound from the audio sensor data to determine one or more characteristics of the vehicle horn sound.

According to an exemplary embodiment, the calculating the risk evaluation may comprise analyzing the visual sensor data to, based on the one or more characteristics, match the vehicle horn sound to a vehicle model.

According to an exemplary embodiment, the calculating the risk evaluation may comprise analyzing the visual sensor data to determine whether one or more sounds from the audio sensor data belong to one or more animals or humans.

According to an exemplary embodiment, the calculating the risk evaluation may comprise analyzing the visual sensor data to determine, based on one or more sound characteristics, whether one or more sounds from the audio sensor data are generated from one or more objects that are approaching the vehicle.

According to an exemplary embodiment, the calculating the risk evaluation may comprise analyzing the visual sensor data to determine, based on one or more sound characteristics, whether one or more sounds from the audio sensor data are generated from one or more objects that are departing from the vehicle.

According to an exemplary embodiment, the calculating the risk evaluation may comprise analyzing the visual sensor data and the audio sensor data to match speech to a visual detection of lip movement.

According to an exemplary embodiment, the calculating the risk evaluation may comprise analyzing the visual sensor data and the audio sensor data to match a horn sound to a visual detection of a secondary vehicle.

### BRIEF DESCRIPTION OF THE DRAWINGS

The accompanying drawings, which are incorporated in and form a part of the Detailed Description, illustrate various non-limiting and non-exhaustive embodiments of the subject matter and, together with the Detailed Description, serve to explain principles of the subject matter discussed below. Unless specifically noted, the drawings referred to in this Brief Description of Drawings should be understood as not being drawn to scale and like reference numerals refer to like parts throughout the various figures unless otherwise specified.

FIG. 1 illustrates a vehicle for performing enhanced self-park maneuvers using audio sensor inputs, according to an exemplary embodiment of the present disclosure.

FIGS. 2-4 illustrates a flowchart of a method for determining a suitable action of a vehicle in response to sound detection, according to an exemplary embodiment of the present disclosure.

FIG. 5 illustrates a method for training a vehicle for performing enhanced self-park maneuvers using audio sensor inputs, according to an exemplary embodiment of the present disclosure;

FIG. 6 illustrates neural network architecture of a neural network, according to an exemplary embodiment of the present disclosure.

FIG. 7A illustrates a graphical representation of a lip signal shown in comparison to a speech signal, according to an exemplary embodiment of the present disclosure.

FIG. 7B illustrates a graphical representation of a lip signal shown in comparison to a speech signal, according to an exemplary embodiment of the present disclosure.

FIG. 8 illustrates an example architecture of a vehicle, according to an exemplary embodiment of the present disclosure.

FIG. 9 illustrates example elements of a computing device, according to an exemplary embodiment of the present disclosure.

### DETAILED DESCRIPTION

The following Detailed Description is merely provided by way of example and not of limitation. Furthermore, there is no intention to be bound by any expressed or implied theory presented in the preceding background or in the following Detailed Description.

Reference will now be made in detail to various exemplary embodiments of the subject matter, examples of which are illustrated in the accompanying drawings. While various embodiments are discussed herein, it will be understood that they are not intended to limit to these embodiments. On the contrary, the presented embodiments are intended to cover alternatives, modifications, and equivalents, which may be included within the spirit and scope of the various embodiments as defined by the appended claims. Furthermore, in this Detailed Description, numerous specific details are set forth in order to provide a thorough understanding of embodiments of the present subject matter. However, embodiments may be practiced without these specific details. In other instances, well known methods, procedures, components, and circuits have not been described in detail as not to unnecessarily obscure aspects of the described embodiments.

Some portions of the detailed descriptions which follow are presented in terms of procedures, logic blocks, processing, and other symbolic representations of operations on data within an electrical device. These descriptions and representations are the means used by those skilled in the data processing arts to most effectively convey the substance of their work to others skilled in the art. In the present application, a procedure, logic block, process, or the like, is conceived to be one or more self-consistent procedures or instructions leading to a desired result. The procedures are those requiring physical manipulations of physical quantities. Usually, although not necessarily, these quantities may take the form of electrical or magnetic signals capable of being stored, transferred, combined, compared, and otherwise manipulated in an electronic system, device, and/or component.

It should be borne in mind, however, that these and similar terms are to be associated with the appropriate physical quantities and are merely convenient labels applied to these quantities. Unless specifically stated otherwise as apparent from the following discussions, it is appreciated that throughout the description of embodiments, discussions utilizing terms such as “determining,” “communicating,” “taking,” “comparing,” “monitoring,” “calibrating,” “estimating,” “initiating,” “providing,” “receiving,” “controlling,” “transmitting,” “isolating,” “generating,” “aligning,” “synchronizing,” “identifying,” “maintaining,” “displaying,” “switching,” or the like, refer to the actions and processes of an electronic item such as: a processor, a sensor processing unit (SPU), a processor of a sensor processing unit, an application processor of an electronic device/system, or the like, or a combination thereof. The item manipulates and transforms data represented as physical (electronic and/or magnetic) quantities within the registers and memories into other data similarly represented as physical quantities within memories or registers or other such information storage, transmission, processing, or display components.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles. In aspects, a vehicle may comprise an internal combustion engine system as disclosed herein.

The terminology used herein is for the purpose of describing particular embodiments only and is not intended to be limiting of the disclosure. As used herein, the singular forms “a.” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

Embodiments described herein may be discussed in the general context of processor-executable instructions residing on some form of non-transitory processor-readable medium, such as program modules, executed by one or more computers or other devices. Generally, program modules include routines, programs, objects, components, data structures, etc., that perform particular tasks or implement particular abstract data types. The functionality of the program modules may be combined or distributed as desired in various embodiments.

In the figures, a single block may be described as performing a function or functions; however, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, modules, logic, circuits, and steps have been described generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example device vibration sensing system and/or electronic device described herein may include components other than those shown, including well-known components.

Various techniques described herein may be implemented in hardware, software, firmware, or any combination thereof, unless specifically described as being implemented in a specific manner. Any features described as modules or components may also be implemented together in an integrated logic device or separately as discrete but interoperable logic devices. If implemented in software, the techniques may be realized at least in part by a non-transitory processor-readable storage medium comprising instructions that, when executed, perform one or more of the methods described herein. The non-transitory processor-readable data storage medium may form part of a computer program product, which may include packaging materials.

The non-transitory processor-readable storage medium may comprise random access memory (RAM) such as synchronous dynamic random access memory (SDRAM), read only memory (ROM), non-volatile random access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, and/or executed by a computer or other processor.

Various embodiments described herein may be executed by one or more processors, such as one or more motion processing units (MPUs), sensor processing units (SPUs), host processor(s) or core(s) thereof, digital signal processors (DSPs), general purpose microprocessors, application specific integrated circuits (ASICs), application specific instruction set processors (ASIPs), field programmable gate arrays (FPGAs), a programmable logic controller (PLC), a complex programmable logic device (CPLD), a discrete gate or transistor logic, discrete hardware components, or any combination thereof designed to perform the functions described herein, or other equivalent integrated or discrete logic circuitry. The term “processor,” as used herein may refer to any of the foregoing structures or any other structure suitable for implementation of the techniques described herein. As employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Moreover, processors can exploit nano-scale architectures such as, but not limited to, molecular and quantum-dot based transistors, switches and gates, in order to optimize space usage or enhance performance of user equipment. A processor may also be implemented as a combination of computing processing units.

In addition, in some aspects, the functionality described herein may be provided within dedicated software modules or hardware modules configured as described herein. Also, the techniques could be fully implemented in one or more circuits or logic elements. A general purpose processor may be a microprocessor, but in the alternative, the processor may be any processor, controller, microcontroller, or state machine. A processor may also be implemented as a combination of computing devices, e.g., a combination of an SPU/MPU and a microprocessor, a plurality of microprocessors, one or more microprocessors in conjunction with an SPU core, MPU core, or any other such configuration. One or more components of an SPU or electronic device described herein may be embodied in the form of one or more of a “chip,” a “package,” an Integrated Circuit (IC).

According to exemplary embodiments, systems and methods for performing enhanced self-park maneuvers using audio sensor inputs are provided. During a self-park maneuver, a human driver may stop the vehicle and look around to determine if the driver hears another vehicle horn honking. Analyzing these auditory cues during a self-park maneuver may increase the safety of self-park maneuvers since sound may be an indicator of risk.

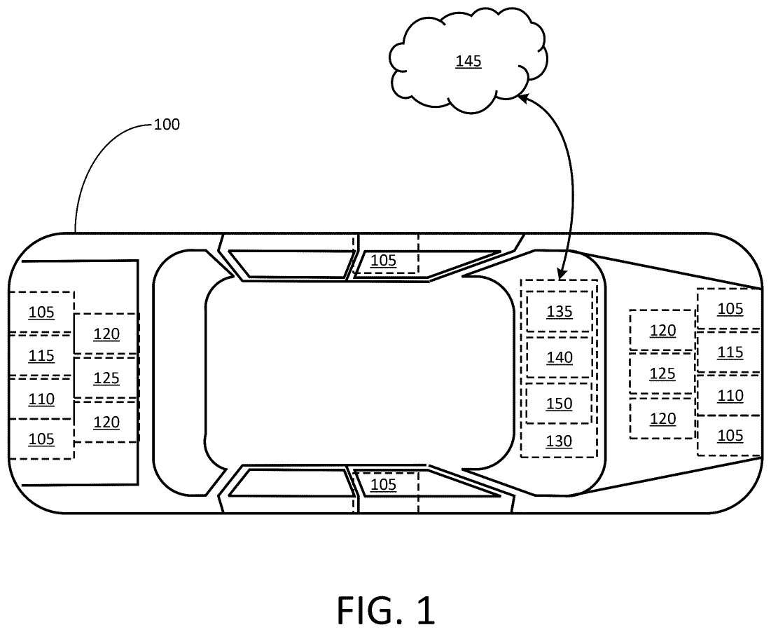

Referring now to FIG. 1, a vehicle 100 for performing enhanced self-park maneuvers using one or more audio sensor inputs 105 is illustratively depicted, in accordance with an exemplary embodiment of the present disclosure.

The vehicle 100 may be an autonomous vehicle (AV), a semi-autonomous vehicle, and/or other suitable vehicle. According to an exemplary embodiment, the vehicle 100 may comprise one or more sensors such as, for example, one or more audio sensors 105, one or more LiDAR sensors 110, one or more radio detection and ranging (radar) sensors 115, one or more cameras 120, one or more position determining sensors 125 (e.g., one or more Global Positioning System devices), and/or one or more other suitable sensors. According to an exemplary embodiment, the one or more audio sensors 105 may comprise one or more sound sensors, one or more ultrasound sensors, and/or other suitable audio sensors.

According to an exemplary embodiment, the one or more sensors may be in electronic communication with one or more computing devices 130. The one or more computing devices 130 may be separate from one or more of the one or more sensors, may be incorporated into one or more of the one or more sensors, and/or may be coupled to one or more of the one or more sensors.

The one or more computing devices 130 may comprise one or more processors 135 and/or memory 140. The memory 140 may be configured to store computing instructions that, when executed by the processor 135, are configured to cause the processor 135 to cause the vehicle 100 to perform a remote smart parking assist (RSPA) function to self-park the vehicle 100. According to an exemplary embodiment, during an RSPA function, control of the vehicle 100 may be performed by the vehicle 100.

According to an exemplary embodiment, the one or more audio sensors 105 are configured to sense one or more sounds within an environment of the vehicle 100. The computing device 130 may be configured to detect whether one or more sounds detected by the one or more audio sensors 105 are concerning sounds. A sound may be labeled a concerning sound when its source and/or cause may effect the vehicle 100 successfully performing the RSPA function. For example, a concerning sound may comprise, but is not limited to, another vehicle's horn sound, human speech, animal sounds (e.g., a dog's bark, a cat's meow, etc.), and/or other suitable concerning sounds.

According to an exemplary embodiment, when a sound has been determined to be a concerning sound, the computing device 130 may be configured to perform the RSPA function in a more cautious manner to aid in preventing any unwanted incidents (e.g., collisions, etc.) that may result from any objects and/or events which may have generated the concerning sound.

According to an exemplary embodiment, the computing device 130 may be configured to identify a source of the concerning sound. The computing device 130 may incorporate sensor input from one or more sensors (e.g., audio data from the one or more audio sensors 105, LiDAR data from the one or more LiDAR sensors 110, radar data from the one or more radar sensors 115, image data from the one or more cameras 120, positioning data from the one or more position determining sensors 125, and/or other data from one or more other suitable sensors) in order to match a concerning sound to the object and/or objects which generated the concerning sound. According to an exemplary embodiment, the computing device 130 may be configured to determine whether the concerning sound is departing the vehicle's 100 location or approaching the vehicle's 100 location based on the input from the one or more sensors.

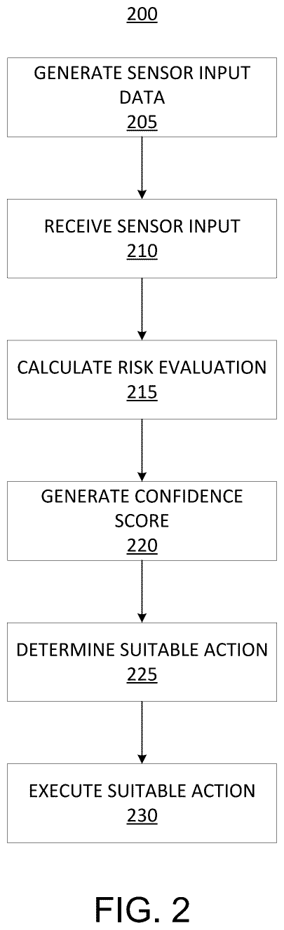

Referring now to FIGS. 2-4, a method 200 for determining a suitable action of a vehicle 100 in response to sound detection is illustratively depicted, in accordance with an exemplary embodiment of the present disclosure.

According to an exemplary embodiment, at 205, the one or more sensors (e.g., the one or more audio sensors 105, the one or more LiDAR sensors 110, the one or more radar sensors 115, the one or more cameras 120, the one or more position determining sensors 125, and/or one or more other suitable sensors) may generate sensor input data correlating with an environment of the vehicle 100. At 210, the one or more computing devices 130 may receive the sensor input data from the one or more sensors.

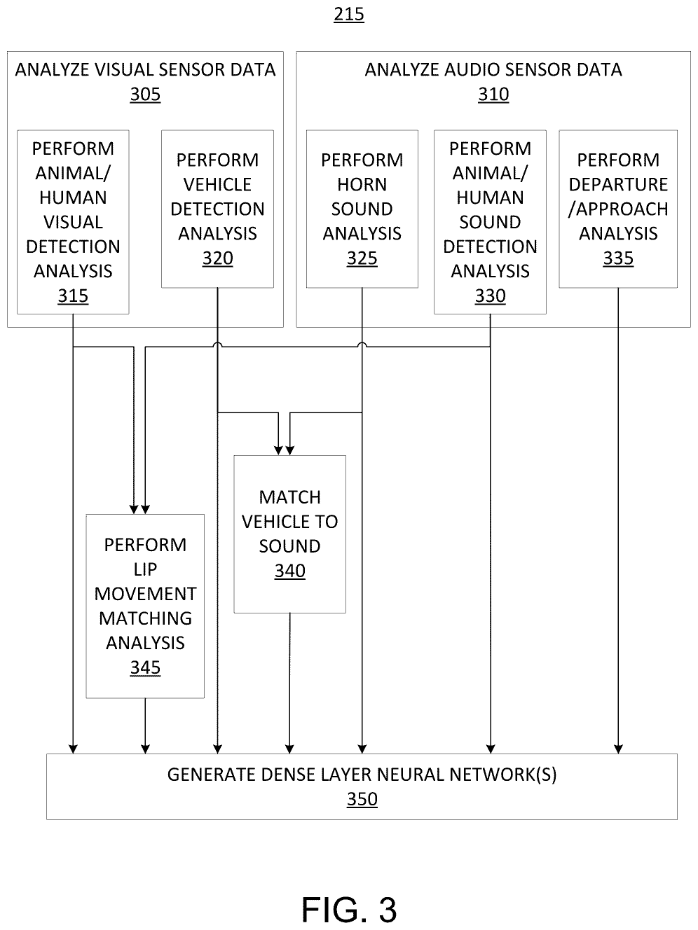

At 215, the one or more computing devices 130 may calculate a risk evaluation based on the sensor input data generated by the one or more sensors. Calculating the risk evaluation, at 215, is shown, in more detail, in FIG. 3.

According to an exemplary embodiment, at 305, visual sensor data (e.g., camera 120 data, LiDAR sensor 110 data, radar sensor 115 data, etc.) analysis may be performed and, at 310, audio sensor data (e.g., audio sensor 105 data, etc.) analysis may be performed.

According to an exemplary embodiment, performing the visual sensor data analysis, at 305, may comprise performing animal/human visual detection analysis, at 315. The animal/human visual detection analysis may comprise determining whether one or humans and/or animals are present within the visual sensor data. According to an exemplary embodiment, performing the visual sensor data analysis, at 305, may comprise performing vehicle detection analysis, at 320. The vehicle detection analysis may comprise determining whether one or more vehicles are present within the visual sensor data.

According to an exemplary embodiment, performing the audio sensor data analysis, at 310, may comprise performing vehicle horn sound analysis, at 325. The vehicle horn sound analysis may comprise identifying a vehicle horn sound (and/or other identifiable sounds such as, e.g., beeping sounds, etc.) from the audio sensor data, analyzing the vehicle horn sound for one or more characteristics, and, based on the one or more characteristics, matching the vehicle horn sound to a vehicle model.

According to an exemplary embodiment, performing the audio sensor data analysis, at 310, may comprise performing animal/human sound detection analysis, at 330. The animal/human sound detection analysis may comprise determining whether one or more sounds from the audio sensor data belong to one or more animals and/or human, thereby detecting one or more animals and/or humans within the audio sensor data.

According to an exemplary embodiment, performing the audio sensor data analysis, at 310, may comprise performing departure/approach analysis, at 335. The departure/approach analysis may comprise determining, based on one or more sound characteristics, whether one or more sounds were generated from one or more objects (e.g., vehicles, animals, humans, etc.) that are approaching the vehicle 100 and/or departing from the vehicle 100.

According to an exemplary embodiment, the vehicle 100 may be configured to use an amplitude of the audio signal to estimate whether the sound source is approaching or departing from the vehicle. Additionally, the vehicle 100 may comprise a microphone array by which it can estimate the direction of the sound source using digital signal processing via, e.g., the computing device 130. According to an exemplary embodiment, the one or more audio sensors 105 and the computing device 130 may be configured to function as an audio array.

According to an exemplary embodiment, based on the results of the vehicle detection analysis, at 320, and the horn sound analysis, at 325, a matching score may be generated, at 340, between the horn sound and a detected vehicle to match a secondary vehicle within the environment of the AV 100 to the detected sound. Vehicle horn sounds are not all the same. Some vehicle models have unique horn sound characteristics. For example, vehicles may use horn sounds, beep sounds, and/or combinations of horn and beep sounds. Additionally, duration, volume, and pitch of horn and/or beep sounds may differ between vehicle models. These characteristics may be used to identify a vehicle model based on sound. For example, when a unique horn sound is detected, and the corresponding vehicle model is found in a camera image, then the vehicle 100 may assume that it has identified the sound source.

According to an exemplary embodiment, based on the results of the animal/human visual detection analysis, at 315, and the animal/human sound detection analysis, at 330, a lip movement matching analysis may be performed, at 345, to match an animal/human sound to corresponding visual sensor data of the animal/human.

According to an exemplary embodiment, human speech may be matched with lip movements. When the vehicle 100 sees a human in its field of view, the lip movement matching analysis may be performed, at 345, to attempt to match lip movements to the detected speech. According to an exemplary embodiment, when there is a match between lip movements and the detected speech, then the vehicle 100 has identified the sound source of the detected speech.

According to an exemplary embodiment, when there are multiple unique speech sounds detected, the vehicle 100 may attempt to match each speech sound, individually, to attempt to match lip movements to each detected speech. Similarly, an animal's mouth movement may be matched with detected sound. For example, a dog's mouth may be matched with a barking sound.

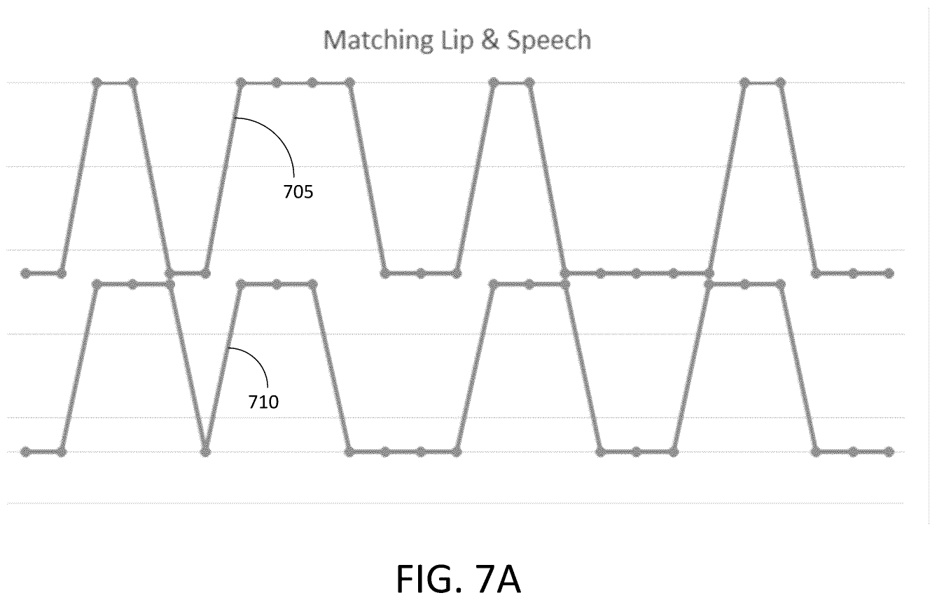

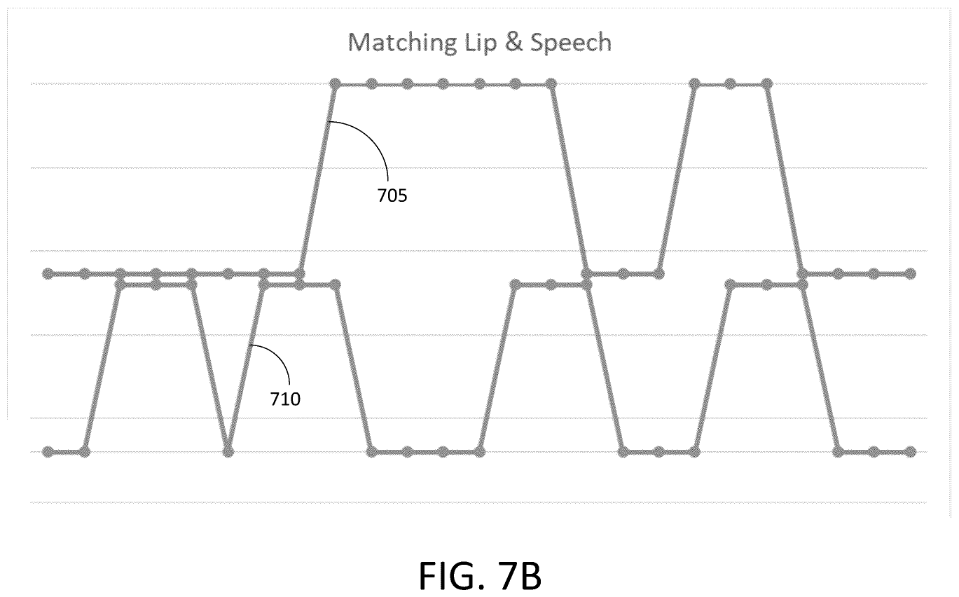

According to an exemplary embodiment, to match the lip movement with the speech, the vehicle 100 may be configured to assign a binary classification to lip movements based on whether or not lips are actively moving. Similarly, the vehicle 100 may be configured to assign a binary classification to the speech to indicate whether or not speech is active. When the lip movement signal matches the speech signal, then it may be judged as a match. For example, as shown in FIGS. 7A, a lip signal 710 from visual processing aligns with a speech signal 705 from audio processing, so the vehicle 100 may be configured to judge the lip movement and the speech as a match. As shown in FIGS. 7B, a lip signal 710 from visual processing does not align with a speech signal 705 from audio processing, so the vehicle 100 may be configured to judge the lip movement and the speech as not being a match. According to an exemplary embodiment, the matching classifier may be configured to perform a cross-correlation calculation between the speech signal 705 and the lip signal 710. When the result exceeds a particular threshold, then the signals 705, 710 are judged as matching. It is noted, however, that other methods of matching speech with lip movements may be incorporated, while maintaining the spirit and functionality of the present disclosure.

According to an exemplary embodiment, each individual functional block of the visual sensor data analysis, at 305, the audio sensor data analysis, at 310, the matching score, at 340, and/or the lip movement analysis, at 345, may comprise a number of neural networks configured to perform the function (e.g. 2D CNN input and a dense layer at the output with ReLU activation).

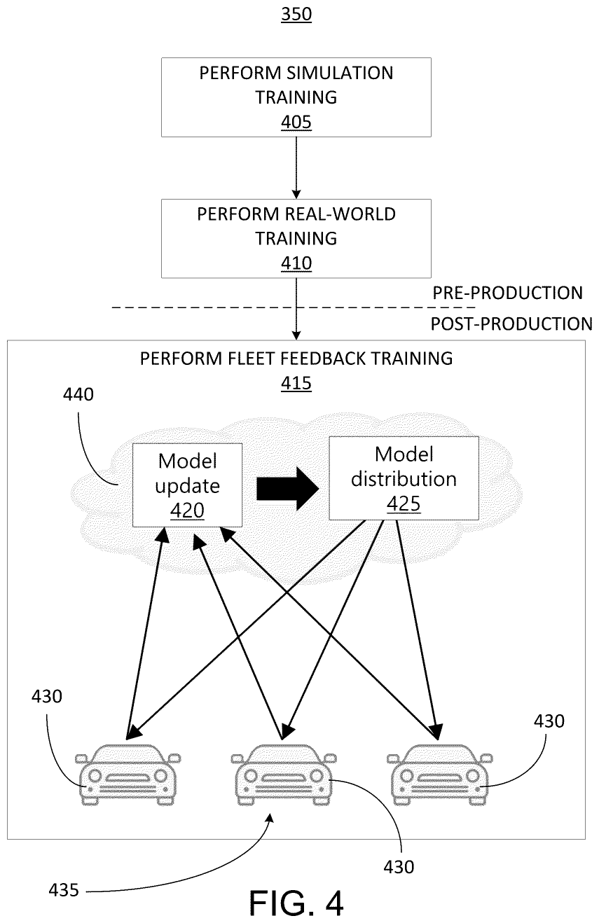

According to an exemplary embodiment, one or more results of the visual sensor data analysis, at 305, the audio sensor data analysis, at 310, the matching score, at 340, and/or the lip movement analysis, at 345, may be used to generate one or more final dense layer neural networks, at 350, as further shows and described in FIG. 4. The one or more final dense layer neural networks may comprise one or more dense layers with a final sigmoid activation function.

According to an exemplary embodiment, generating the one or more final dense layer neural networks may comprise performing system training. The system training may comprise performing simulation training, at 405, and then performing real-world training, at 410.

According to an exemplary embodiment, the system training starts in a simulation environment, at 405, since the system needs to experience many training examples to develop to a reasonable model that works in the real world. According to an exemplary embodiment, the simulation training may comprise training under many collisions while the AV 100 is learning a reasonable model.

According to an exemplary embodiment, after sufficient simulation training, the system may be trained using real-world scenario training, at 410, to fine-tune the model to account for real-world details that cannot be captured in simulations. According to an exemplary embodiment, the simulation training, at 405, and the real-world training, at 410, may be performed prior to vehicle production.

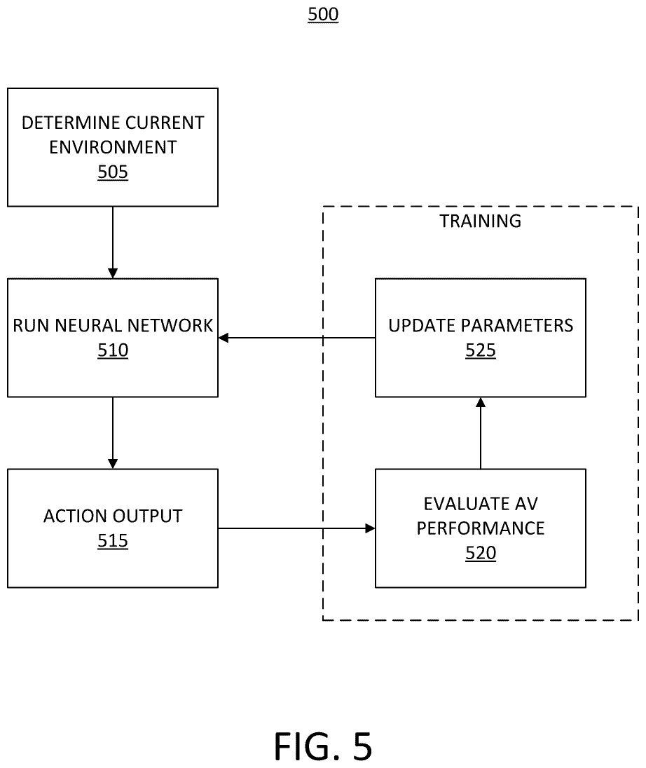

According to an exemplary embodiment, the simulation training, at 405, and/or the real-world training, at 410, may be performed using a method training a neural network, such as, e.g., method 500 of FIG. 5.

According to an exemplary embodiment, the method 500 for training the neural network may comprise determining a status of the current environment of the AV 100, at 505. Determining the status of the current environment of the AV 100 may comprise receiving sensor data from the one or more sensors (e.g., the audio data 605 from the one or more audio sensors 105, LiDAR data 610 from the one or more LiDAR sensors 110, radar data 620 from the one or more radar sensors 115, image data 680 from the one or more cameras 120, positioning data 625 from the one or more position determining sensors 125, and/or other data from one or more other suitable sensors) and detecting, identifying, and classifying one or more objects within the environment of the AV 100.

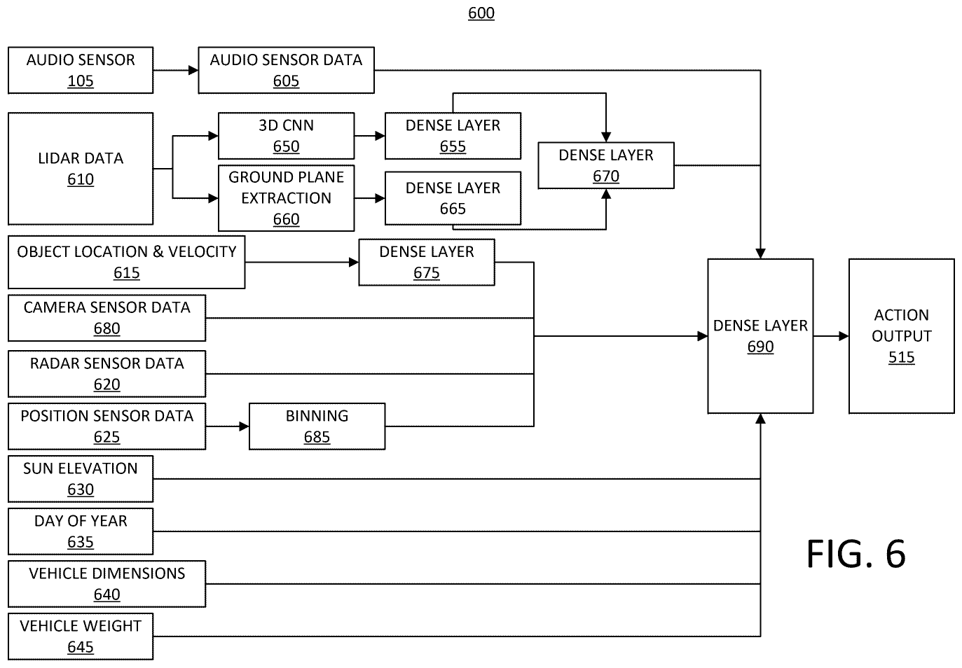

At 510, this status of the current environment may be sent to a neural network, which is run in order to determine an optimal sampling rate of one or more of the one or more sensors. Neural network architecture 600 of the neural network is shown in FIG. 6, in accordance with an exemplary embodiment of the present disclosure.

According to an exemplary embodiment, one or more environmental factors are input into the neural network. The one or more environmental factors may comprise, but are not limited to, the audio sensor data 605, the LiDAR data 610, the location and/or velocity data 615 for one or more objects, the light sensor data 620, the position sensor data 625, the sun elevation 630, the day of the year 635, the vehicle dimensions 640 of the AV, the vehicle weight 645 of the AV, and/or one or more other suitable environmental factors.

According to an exemplary embodiment, the 3D point cloud from the LiDAR data 305 may be input into a convolutional neural network (CNN) 650 configured to extract feature data from the 3D point cloud. The extracted features may be passed to a dense layer 655. According to an exemplary embodiment, the 3D point cloud from the LiDAR data 610 may be input into a ground plane extraction module 660 configured to extract ground plane information from the 3D point cloud, which then may be input into a dense layer 665. The 3D CNN data and the ground plane extraction data may then be condensed at dense layer 670.

According to an exemplary embodiment, the location and velocity data 615 of the one or more objects may be condensed at dense layer 675.

According to an exemplary embodiment, the position sensor data 625 may be binned 685.

According to an exemplary embodiment, all of the sensor data may be condensed in one or more dense layers 690. This condensed data may then be analyzed in order to generate an action output 515 (as also shown in FIG. 5).

It is noted that the layers shown and described in FIG. 6 are examples and greater or fewer layers may be incorporated into the architecture of the neural network, while maintaining the spirit and functionality of the present disclosure.

According to an exemplary embodiment, the action output 515 of the neural network may be an optimal action for the AV 100 to take in view of the current status of the environment of the AV 100. According the suitable action determined, at 515, may be similar or equal to the suitable action determined, at 225, as shown in FIG. 2.

According to an exemplary embodiment, each sensor and/or otherwise controllable points by the AV 100 may be configured to be individually tuned by the neural network, enabling flexibility in finding the optimal setting or settings. For example, the AV 100 may determine that certain environments need cameras 120 but do not need radar sensors 115 and/or LiDAR sensors 110. In this case, the AV 100 many be configured to maintain a high camera 120 sensor rate but decrease or shutdown the one or more radar sensors 115 and/or LiDAR sensors 110.

According to an exemplary embodiment, during simulation training, at 405, and/or during real-world training, at 410, the system may be configured to continuously monitor parking performance, including, but not limited to, object classification (including, but not limited to, identifying one or more objects, identifying a location of the one or more objects, identifying whether the one or more objects are approaching and/or departing, etc.) accuracy, in order to evaluate the success of the action output, at 515, generated by the neural network, at 510.

At 520, the accuracy of the action output and/or the accuracy of the AV 100 in parking and identifying and/or classifying one or more objects during the RSPA function may be evaluated during a training function (e.g., the simulation training function, at 405, and/or the real-world training function, at 410).

According to an exemplary embodiment, the evaluation, at 520, may be used to calculate updated parameters of the neural network, thus creating a training feedback loop. The parameters may be updated, at 525, according to the generated updated parameters. The updated parameters may then be input into the neural network which can then be run again, at 510.

The end result of the training feedback loop is maximizing AV 100 performance during the completion of RSPA functions. According to an exemplary embodiment, the algorithm for quantifying AV 100 performance during the completion of RSPA functions is designed to penalize undesirable driving events (e.g., collisions, hard braking, etc.) and reward desirable driving events (e.g., successful parking, avoiding collisions, successful identification/classification of objects, etc.).

According to an exemplary embodiment, after vehicle production, the system may continue to be trained, at 415, using data feedback from the vehicle fleet. According to an exemplary embodiment, each vehicle 430 in the vehicle fleet 435 that utilizes one or more adaptive sensing methods may be configured to transmit data to a cloud storage 440 using suitable transmission means (e.g., using 4G LTE and/or other suitable transmission means).

According to an exemplary embodiment, the model may be updated, at 420, in the cloud 440 and then distributed, at 425, back to individual vehicles 430 of the fleet 435. According to an exemplary embodiment, the system may be configured to distinguish based on region, so that all vehicles 430 in a particular region share data and model updates.

According to an exemplary embodiment, a confidence score may be generated, at 220, based on the results of the risk evaluation calculation, at 215. The confidence score is indicative of the vehicle's 100 confidence that it can safely park the vehicle 100 during an RSPA function. According to an exemplary embodiment, the confidence score may be used to determine a suitable action of the vehicle 100, at 225, which may be executed, at 230, causing the vehicle 100 to perform the suitable action.

According to an exemplary embodiment, the confidence score may be calculated to be low when it is below a first threshold, may be calculated to be medium when it is above the first threshold and below a second threshold, and may be calculated to be high when it is above the second threshold. The values of the first threshold and the second threshold may be subject to tuning, depending, e.g., on original equipment manufacturer (OEM) preferences, customer expectations, and/or other suitable factors.

According to an exemplary embodiment, when the confidence score is low, an RSPA function may be terminated and control of the vehicle 100 may be returned to the driver.

According to an exemplary embodiment, when the confidence score is medium, the RSPA function may continue, but with the implementation of one or more cautionary functions. The one or more cautionary functions may comprise reducing the speed of the vehicle 100, turning on headlights and/or hazard lights, increasing a sensor sampling rate of the one or more sensors, and/or other suitable cautionary functions. For example, when there are one or more people in a parking space, when the one or more sensors of the vehicle 100 are able to detect the speech of the one or more people but are not able to visually detect the one or more people, the confidence score may be medium due to the unknown speech sound. Upon proceeding cautiously, if the one or more sensors of the vehicle 100 visually detect the one or more people within the parking space and match the speech to the one or more people in the parking space, the vehicle 100 may determine that the people are in the parking path of the vehicle and the confidence score would be low and control of the vehicle 100 may be returned to the driver.

According to an exemplary embodiment, when the confidence score is high, the RSPA function may continue as normal. For example, when there are two people talking in view of the vehicle 100 in a parking space, when the one or more sensors of the vehicle 100 are able to detect the speech of the one or more people and are able to visually detect the one or more people, the vehicle 100 may be able to match the speech of the people with the captured visuals of the people and determine that the people are not in the parking path of the vehicle. In this example, the confidence score may be high and the RSPA function may continue as normal.

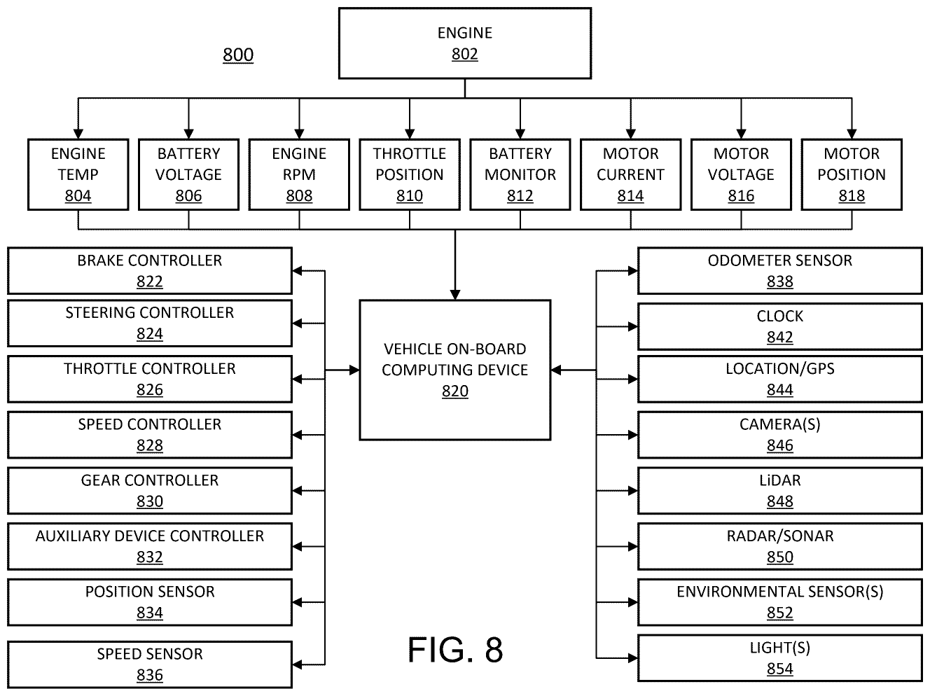

Referring now to FIG. 8, an example vehicle system architecture 800 for a vehicle is provided, in accordance with an exemplary embodiment of the present disclosure. The following discussion of vehicle system architecture 700 is sufficient for understanding one or more components of vehicle 100 and vehicle 430.

As shown in FIG. 8, the vehicle system architecture 800 may comprise an engine, motor or propulsive device 802 and various sensors 804-818 for measuring various parameters of the vehicle system architecture 800. In gas-powered or hybrid vehicles having a fuel-powered engine, the sensors 804-818 may comprise, for example, an engine temperature sensor 804, a battery voltage sensor 806, an engine Rotations Per Minute (RPM) sensor 808, and/or a throttle position sensor 810. If the vehicle is an electric or hybrid vehicle, then the vehicle may comprise an electric motor, and accordingly may comprise sensors such as a battery monitoring system 812 (to measure current, voltage and/or temperature of the battery), motor current 814 and voltage 816 sensors, and motor position sensors such as resolvers and encoders 818.

Operational parameter sensors that are common to both types of vehicles may comprise, for example: a position sensor 834 such as an accelerometer, gyroscope and/or inertial measurement unit; a speed sensor 836; and/or an odometer sensor 838. The vehicle system architecture 800 also may comprise a clock 842 that the system uses to determine vehicle time and/or date during operation. The clock 842 may be encoded into the vehicle on-board computing device 820, it may be a separate device, or multiple clocks may be available.

The vehicle system architecture 800 also may comprise various sensors that operate to gather information about the environment in which the vehicle is traveling. These sensors may comprise, for example: a location sensor 844 (for example, a Global Positioning System (GPS) device); object detection sensors such as one or more cameras 846; a LiDAR sensor system 848; and/or a radar and/or a sonar system 850. The sensors also may comprise environmental sensors 852 such as, e.g., a humidity sensor, a precipitation sensor, a light sensor, and/or ambient temperature sensor. The object detection sensors may be configured to enable the vehicle system architecture 800 to detect objects that are within a given distance range of the vehicle in any direction, while the environmental sensors 852 may be configured to collect data about environmental conditions within the vehicle's area of travel. According to an exemplary embodiment, the vehicle system architecture 800 may comprise one or more lights 854 (e.g., headlights, flood lights, flashlights, etc.).

During operations, information may be communicated from the sensors to an on-board computing device 820 (e.g., computing device 130, computing device 900). The on-board computing device 820 may be configured to analyze the data captured by the sensors and/or data received from data providers and may be configured to optionally control operations of the vehicle system architecture 800 based on results of the analysis. For example, the on-board computing device 820 may be configured to control: braking via a brake controller 822; direction via a steering controller 824; speed and acceleration via a throttle controller 826 (in a gas-powered vehicle) or a motor speed controller 828 (such as a current level controller in an electric vehicle); a differential gear controller 830 (in vehicles with transmissions); and/or other controllers. The brake controller 822 may comprise a pedal effort sensor, pedal effort sensor, and/or simulator temperature sensor, as described herein.

Geographic location information may be communicated from the location sensor 844 to the on-board computing device 820, which may then access a map of the environment that corresponds to the location information to determine known fixed features of the environment such as streets, buildings, stop signs and/or stop/go signals. Captured images from the cameras 846 and/or object detection information captured from sensors such as LiDAR 848 may be communicated from those sensors to the on-board computing device 820. The object detection information and/or captured images may be processed by the on-board computing device 820 to detect objects in proximity to the vehicle. Any known or to be known technique for making an object detection based on sensor data and/or captured images may be used in the embodiments disclosed in this document.

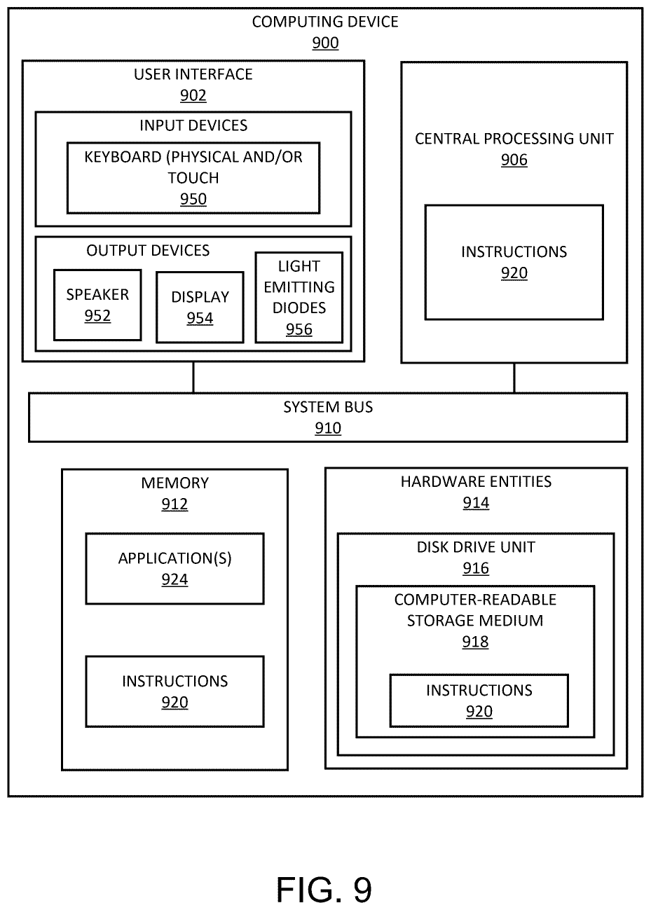

Referring now to FIG. 9, an illustration of an example architecture for a computing device 900 is provided. According to an exemplary embodiment, one or more functions of the present disclosure may be implemented by a computing device such as, e.g., computing device 800 or a computing device similar to computing device 900. Computing device 800 may be a quantum computer, a classical computer, and/or have one or more components configured to perform one or more quantum and/or classical computing functions. Computing device 130 may be an example of computing device 800 and/or may comprise one or more components of computing device 900.

The hardware architecture of FIG. 9 represents one example implementation of a representative computing device configured to implement at least a portion of the systems/devices (e.g., tractor-trailer 100) and method(s)/control logic(s) (e.g., method 200, method 215, method 350, method 500, and Neural network architecture 600) described herein.

Some or all components of the computing device 900 may be implemented as hardware, software, and/or a combination of hardware and software. The hardware may comprise, but is not limited to, one or more electronic circuits. The electronic circuits may comprise, but are not limited to, passive components (e.g., resistors and capacitors) and/or active components (e.g., amplifiers and/or microprocessors). The passive and/or active components may be adapted to, arranged to, and/or programmed to perform one or more of the methodologies, procedures, or functions described herein.

As shown in FIG. 9, the computing device 900 may comprise a user interface 902 (e.g., a graphical user interface), a Central Processing Unit (“CPU”) 906, a system bus 910, a memory 912 connected to and accessible by other portions of computing device 900 through system bus 910, and hardware entities 914 connected to system bus 910. The user interface may comprise input devices and output devices, which may be configured to facilitate user-software interactions for controlling operations of the computing device 900. The input devices may comprise, but are not limited to, a physical and/or touch keyboard 940. The input devices may be connected to the computing device 900 via a wired or wireless connection (e.g., a Bluetooth® connection). The output devices may comprise, but are not limited to, a speaker 942, a display 944, and/or light emitting diodes 946.

At least some of the hardware entities 914 may be configured to perform actions involving access to and use of memory 912, which may be a Random Access Memory (RAM), a disk driver and/or a Compact Disc Read Only Memory (CD-ROM), among other suitable memory types. Hardware entities 914 may comprise a disk drive unit 916 comprising a computer-readable storage medium 918 on which may be stored one or more sets of instructions 920 (e.g., programming instructions such as, but not limited to, software code) configured to implement one or more of the methodologies, procedures, or functions described herein. The instructions 920 may also reside, completely or at least partially, within the memory 912 and/or within the CPU 906 during execution thereof by the computing device 900.

The memory 912 and the CPU 906 may also constitute machine-readable media. The term “machine-readable media”, as used here, refers to a single medium or multiple media (e.g., a centralized or distributed database, and/or associated caches and servers) that store the one or more sets of instructions 920. The term “machine-readable media”, as used here, also refers to any medium that is capable of storing, encoding, or carrying a set of instructions 920 for execution by the computing device 900 and that cause the computing device 900 to perform any one or more of the methodologies of the present disclosure.

What has been described above includes examples of the subject disclosure. It is, of course, not possible to describe every conceivable combination of components or methodologies for purposes of describing the subject matter, but it is to be appreciated that many further combinations and permutations of the subject disclosure are possible. Accordingly, the claimed subject matter is intended to embrace all such alterations, modifications, and variations that fall within the spirit and scope of the appended claims.

In particular and in regard to the various functions performed by the above described components, devices, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter.

The aforementioned systems and components have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components. Any components described herein may also interact with one or more other components not specifically described herein.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

Thus, the embodiments and examples set forth herein were presented in order to best explain various selected embodiments of the present invention and its particular application and to thereby enable those skilled in the art to make and use embodiments of the invention. However, those skilled in the art will recognize that the foregoing description and examples have been presented for the purposes of illustration and example only. The description as set forth is not intended to be exhaustive or to limit the embodiments of the invention to the precise form disclosed.

What is claimed is:

1. A system for performing enhanced self-park maneuvers, comprising:
one or more audio sensors coupled to a vehicle configured to generate audio sensor data of an environment of the vehicle;
one or more visual sensors coupled to the vehicle configured to generate visual sensor data of an environment of the vehicle; and
a computing device, comprising a processor and a memory, wherein the memory comprises instructions that, when executed by the processor, are configured to cause the processor to:
cause the vehicle to perform a remote smart parking assist (RSPA) function to self-park the vehicle;
receive the audio sensor data and the visual sensor data;
calculate a risk evaluation based on the audio sensor data and the visual sensor data;
using a neural network, generate a confidence score based on the risk evaluation; and
determine one or more suitable actions for the vehicle to take, based on the confidence score.

2. The system of claim 1, wherein calculating the risk evaluation comprises training the neural network according to a training feedback loop.

3. The system of claim 1, wherein generating the confidence score comprises:
calculating the confidence score to be low when the confidence score is below a first threshold;
calculating the confidence score as medium when the confidence score is above the first threshold and below a second threshold; and
calculating the confidence score as high when the confidence score is above the second threshold.

4. The system of claim 3, wherein:
when the confidence score is low, the one or more suitable actions comprise:
terminating the RSPA function; and
returning control of the vehicle to a driver;
when the confidence score is medium, the one or more suitable actions comprise:
proceeding with the RSPA function with implementation of one or more cautionary functions; and
when the confidence score is high, the one or more suitable actions comprise:
proceeding with completion of the RSPA function.

5. The system of claim 4, wherein the one or more cautionary functions comprise one or more of the following:
reducing a speed of the vehicle;
turning on headlights of the vehicle;
turning on hazard lights of the vehicle;
increasing a sensor sampling rate of the one or more audio sensors; or
increasing a sensor sampling rate of the one or more visual sensors.

6. The system of claim 4, wherein the instructions, when executed by the processor, are further configured to cause the processor to perform the one or more suitable actions.

7. The system of claim 1, wherein the calculating the risk evaluation comprises analyzing the visual sensor data to:
determine whether one or more humans and/or animals are present within the visual sensor data; and
determine whether one or more vehicles are present within the visual sensor data.

8. The system of claim 1, wherein the calculating the risk evaluation comprises analyzing the visual sensor data to:
identify a vehicle horn sound from the audio sensor data to determine one or more characteristics of the vehicle horn sound;
based on the one or more characteristics, match the vehicle horn sound to a vehicle model;
determine whether one or more sounds from the audio sensor data belong to one or more animals or humans;
determine, based on one or more sound characteristics, whether one or more sounds from the audio sensor data are generated from one or more objects that are approaching the vehicle; and
determine, based on one or more sound characteristics, whether one or more sounds from the audio sensor data are generated from one or more objects that are departing from the vehicle.

9. The system of claim 1, wherein the calculating the risk evaluation comprises analyzing the visual sensor data and the audio sensor data to match speech to a visual detection of lip movement.

10. The system of claim 1, wherein the calculating the risk evaluation comprises analyzing the visual sensor data and the audio sensor data to match a horn sound to a visual detection of a secondary vehicle.

11. The system of claim 1, further comprising the vehicle,
wherein the vehicle comprises:
an autonomous vehicle; or
a semi-autonomous vehicle.

12. A method for performing enhanced self-park maneuvers, comprising:
generating audio sensor data of an environment of a vehicle via one or more audio sensors coupled to the vehicle;
generating visual sensor data of an environment of the vehicle via one or more visual sensors coupled to the vehicle; and
using a computing device, comprising a processor and a memory,
receiving the audio sensor data and the visual sensor data;
calculating a risk evaluation based on the audio sensor data and the visual sensor data;
using a neural network, generating a confidence score based on the risk evaluation;
determining one or more suitable actions for the vehicle to take, based on the confidence score; and
performing the one or more suitable actions.

13. The method of claim 12, wherein calculating the risk evaluation comprises training the neural network according to a training feedback loop.

14. The method of claim 12, wherein generating the confidence score comprises:
calculating the confidence score to be low when the confidence score is below a first threshold;
calculating the confidence score as medium when the confidence score is above the first threshold and below a second threshold; and
calculating the confidence score as high when the confidence score is above the second threshold.

15. The method of claim 14, wherein:
when the confidence score is low, the one or more suitable actions comprise:
terminating a remote smart parking assist (RSPA) function; and
returning control of the vehicle to a driver;
when the confidence score is medium, the one or more suitable actions comprise:
proceeding with the RSPA function with implementation of one or more cautionary functions; and
when the confidence score is high, the one or more suitable actions comprise:
performing the RSPA function.

16. The method of claim 15, wherein the one or more cautionary functions comprise one or more of the following:
reducing a speed of the vehicle;
turning on headlights of the vehicle;
turning on hazard lights of the vehicle;
increasing a sensor sampling rate of the one or more audio sensors; or
increasing a sensor sampling rate of the one or more visual sensors.

17. The method of claim 12, wherein the calculating the risk evaluation comprises analyzing the visual sensor data to:
determine whether one or more humans and/or animals are present within the visual sensor data; and
determine whether one or more vehicles are present within the visual sensor data.

18. The method of claim 12, wherein the calculating the risk evaluation comprises analyzing the visual sensor data to:
identify a vehicle horn sound from the audio sensor data to determine one or more characteristics of the vehicle horn sound;
based on the one or more characteristics, match the vehicle horn sound to a vehicle model;
determine whether one or more sounds from the audio sensor data belong to one or more animals or humans;
determine, based on one or more sound characteristics, whether one or more sounds from the audio sensor data are generated from one or more objects that are approaching the vehicle; and
determine, based on one or more sound characteristics, whether one or more sounds from the audio sensor data are generated from one or more objects that are departing from the vehicle.

19. The method of claim 12, wherein the calculating the risk evaluation comprises analyzing the visual sensor data and the audio sensor data to match speech to a visual detection of lip movement.

20. The method of claim 12, wherein the calculating the risk evaluation comprises analyzing the visual sensor data and the audio sensor data to match a horn sound to a visual detection of a secondary vehicle.
